(19) United States
(12) Patent Application Publication
(10) Pub. No.: US 2012/0110454 A1
(43) Pub. Date: May 3, 2012

(54) METHOD AND APPARATUS FOR PROVIDING USER INTERFACE FOR MEDIA CONTENTS IN USER EQUIPMENT

(76) Inventors: Haeng-Suk Chae, Gyeonggi-do (KR); Kyoung-Tae Choi, Gyeonggi-do (KR)

(21) Appl. No.: 13/282,805

(22) Filed: Oct. 27, 2011

(30) Foreign Application Priority Data
Oct. 27, 2010 (KR) 10-2010-0105336

(51) Int. Cl. G06F 3/01

(52) U.S. Cl. 715/716

(57) ABSTRACT

Apparatus and method for providing a user interface for media contents in a user equipment. In order to provide the user interface, the background screen of the user interface may be formed from at least one image. Each image of the at least one image may represent a respective one of the retrieved media contents. The user interface having the background screen formed from the at least one image may be displayed. A desired image may be selected from the at least one image of the displayed user interface, and a desired media content corresponding to the selected desired image may be played.

### CROSS REFERENCE TO PRIOR APPLICATIONS

The present application claims priority under 35 U.S.C. §119 to Korean Patent Application No. 10-2010-0105336 (filed on Oct. 27, 2010), which is hereby incorporated by reference in its entirety.

### FIELD OF THE INVENTION

Apparatuses and methods consistent with the present invention relate to providing a user interface, and more particularly, to providing a user interface for media contents in a user equipment.

### BACKGROUND OF THE INVENTION

Various types of user equipment have been introduced. A typical user equipment has functions that allow a user to store and play back media contents, for example, audio tracks and video files. By carrying a portable user equipment, a user can listen to and/or watch media contents regardless of location. Due to such convenience, user equipments have been receiving greater attention lately.

In general, a user may download such media contents from an external source, such as a personal computer (PC) or the Internet, to a user equipment in order to store the media contents in the user equipment. Such media contents, for example, audio tracks and video files, may be stored in the PC or downloaded directly from an Internet server. Particularly, a user may select desired media contents stored in the PC and download the selected media contents from the PC to the user equipment through a cable or a wireless link. After downloading the media contents, a user may play back one of the downloaded media contents to execute a respective application. For example, a user may execute an audio player to play back audio tracks or a video player to play back video files. Generally, a user equipment provides a user interface that enables a user to select an application to play back desired media contents. The user interface may be a main menu with a list of applications or a home screen with icons of applications.

A user may desire to watch a video file while listening to an audio track stored in a user equipment. In this case, the user may be required to execute a respective application, for example, a video player, to play back a video file. In order to execute the respective application, the user may be required to open a main menu and select a menu to run the respective application. Alternatively, the user may be required to open a home screen and select a respective icon displayed on the home screen to execute the respective application. It may be an inconvenient procedure and burdensome to users. Accordingly, there is a need for improving play back of various types of media contents.

### SUMMARY OF THE INVENTION

Embodiments of the present invention overcome the above disadvantages and other disadvantages not described above. Also, the present invention is not required to overcome the disadvantages described above, and an embodiment of the present invention may not overcome any of the problems described above.

In accordance with an aspect of the present invention, a method for providing a user interface for media contents in a user equipment may improve user convenience.

In accordance with another aspect of the present invention, an apparatus for providing a user interface for media contents in a user equipment may improve user convenience.

In accordance with an embodiment of the present invention, a method may be provided for a user interface for media contents in a user equipment. In the method, media contents may be retrieved from a memory of the user equipment. The background screen of the user interface may be formed from at least one image. Each image of the at least one image may represent a respective one of the retrieved media contents. The user interface having the background screen formed from the at least one image may be displayed. A desired image may be selected from the at least one image of the displayed user interface. A desired media content corresponding to the selected desired image may be played.

In order to form the background screen of the user interface, the background screen of the user interface may be divided into at least one sub-screen based on the number of the media contents. The at least one image representing the media contents may be extracted. The extracted at least one image may be arranged in the at least one sub-screen to form the background screen. The arranged at least one image may be mapped with corresponding media contents. The result of the mapping may be stored.

When dividing the background screen into the at least one sub-screen, the background screen may be divided into the at least one sub-screen such that each one of the at least one sub-screen has the same size or such that ones of the at least one sub-screen have varying sizes. Furthermore, the background screen may be divided into a number of sub-screens corresponding to the number of the media contents stored in the memory.

While arranging the extracted at least one image in the at least one sub-screen, at least one of a size and a position of each image of the extracted at least one image may be controlled according to a user preference associated with each of the media contents.

While displaying the user interface having the background screen formed from the at least one image, a selection input may be received for selecting a desired type of media content to be displayed. Then, the media contents may be sorted according to type. Ones of the at least one image that correspond to the desired type of media content may be displayed. The desired type of media content may include a photograph, music, or video.

In order to play the desired media content corresponding to the selected image, a selection input may be received for selecting the desired image from the background screen. Then, media content information corresponding to the selected desired image may be extracted based on the stored result of the mapping. An application corresponding to a type of the desired media content may be executed. The desired media content may be played using the corresponding application.

Furthermore, the information corresponding to the desired media may be displayed while the desired media content is played.

In accordance with another embodiment of the present invention, an apparatus may be provided for a user interface for media contents in a user equipment. The apparatus may include an input unit, a memory, a formation unit, and a display unit.

The input unit may be configured to receive an input from a user. The memory may be configured to store the media contents. The formation unit may be configured to retrieve the media contents from the memory and configured to form a background screen of the user interface from at least one image. Each image of the at least one image may represent a respective one of the retrieved media contents. The display unit may be configured to display the user interface having the background screen formed from the at least one image representing the media contents, and configured to display information corresponding to an image selected from the displayed background screen formed from the at least one image.

The formation unit may be further configured to divide the background screen of the user interface into at least one sub-screen based on the number of the media contents stored in the memory, extract the at least one image, arrange the extracted at least one image in the at least one sub-screen to form the background screen, map the arranged at least one image with corresponding media contents, and store the result of the mapping in the memory.

The formation unit may be configured to divide the background screen into the at least one sub-screen such that each one of the at least one sub-screen has a same size or such that ones of the at least one sub-screen have varying sizes. The formation united may also be configured to divide the background screen into a number of sub-screens corresponding to the number of the media contents stored in the memory.

Furthermore, at least one of a size and a position of each image of the extracted at least one image may be controlled according to a user preference associated with each of the media contents.

The formation unit may be further configured to receive a selection input for selecting a desired type of media content to be displayed while the user interface having the background screen formed from the at least one image is displayed, sort the media contents according to type, and display, on the display unit, ones of the at least one image that correspond to the desired type of media content. The desired type of media content may include a photograph, music, or video.

The at least one image representing the media contents may include an image that is included in the media contents.

In accordance with still another embodiment of the present invention, a computer program product embodied on a computer-readable storage medium may be provided. When executed by a computer of a user equipment, the computer program product may cause the computer to perform a method, the method including retrieving media contents from a memory of the user equipment, forming a background screen of the user interface from at least one image, displaying the user interface having the background screen formed from the at least one image representing the media contents, selecting a desired image from the at least one image of the displayed user interface, and playing a desired media content corresponding to the selected desired image. Each image of the at least one image may represent a respective one of the retrieved media contents.

### BRIEF DESCRIPTION OF THE DRAWINGS

The above and/or other aspects of the present invention will become apparent and more readily appreciated from the following description of embodiments, taken in conjunction with the accompanying drawings, of which:

FIG. 1 illustrates a user equipment configured to provide a user interface to play media contents, in accordance with an embodiment of the present invention;

FIG. 2 illustrates the playing of a media content through a media wall formed with one or more images, in accordance with an embodiment of the present invention;

FIG. 3 illustrates an example of displaying a media wall by sorting media contents according to type, in accordance with an embodiment of the present invention;

FIG. 4 illustrates a method for providing a media wall as a user interface for media contents in a user equipment, in accordance with an embodiment of the present invention; and

FIG. 5 illustrates a method for setting up a media wall of a user interface in a user equipment, in accordance with an embodiment of the present invention.

### DETAILED DESCRIPTION OF THE INVENTION

Reference will now be made in detail to embodiments of the present invention, examples of which are illustrated in the accompanying drawings, wherein like reference numerals refer to like elements throughout. The embodiments are described below, in order to explain the present invention by referring to the figures.

In accordance with an embodiment of the present invention, a user equipment may set up a background screen of a user interface with a plurality of images each representing a respective one of media contents stored in a memory. When a user selects one of the images from the background screen of the user interface, the user equipment may play back a desired media content corresponding to the selected image by running a corresponding application. Accordingly, a user may conveniently and quickly enjoy his/her favorite media contents.

Such a background of a user interface for media contents may be referred to as a media wall, an active background, a live background, an active wallpaper, and/or a live wallpaper. Hereinafter, for convenience and ease of understanding, the term “media wall” will be used throughout the specification in order to describe any or all of the background, the active background, the live background, the active wallpaper, and the live wallpaper for a user interface for media contents such as but not limited to photos, music, video clips, movies, etc. In general, the media wall may be a type of application that functions as a background image of a user interface and interacts with the user in response to a user action. For example, the media wall may be configured of a plurality of icons or images each associated with a set of events. When a user selects one of the icons or images in the media wall, the user equipment may perform a set of events associated with the selected icon or image.

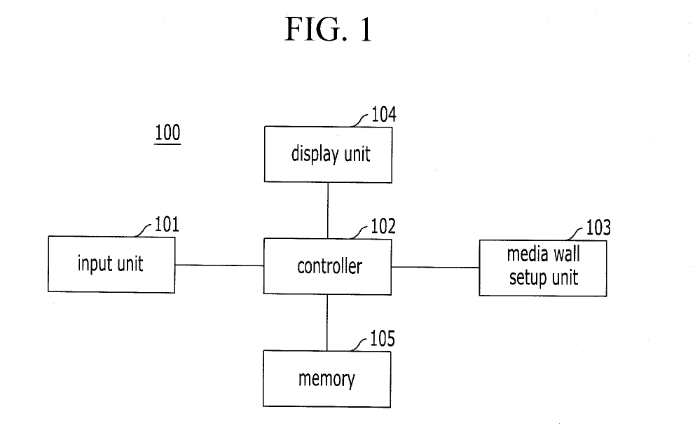

FIG. 1 illustrates a user equipment 100 providing a media wall of a user interface for media contents, in accordance with an embodiment of the present invention. A user may enable or access the media wall by flicking a home screen of the user equipment toward the left, right, up or down by using a finger or various types of pointing devices.

Referring to FIG. 1, the user equipment 100 may include an input unit 101, a controller 102, a media wall setup unit 103, a display unit 104, and a memory 105.

The input unit 101 may include or provide a user interface (UI) for receiving a user input from a user. The user input may include any action that generates a signal to invoke one or more functions of the user equipment. For example, the user input may be a control command or a function selection command for controlling general operations of the user equipment 100. The function selection command may be a command to invoke a media wall setup function. Furthermore, the user input may include an input for selecting a type of media contents to be displayed. For example, the user input may be a selection of a desired type of media content that a user desires to see, listen to or watch. For example, types of media content may include a photo, music, and video.

The input unit 101 may receive a selection signal from a user to select an image displayed as the media wall. For example, a user may use the input unit 101 to select an image of the media wall.

The controller 102 may perform operations for controlling constituent elements of the user equipment 100 including the input unit 101, the media wall setup unit 103, the display unit 104, and the memory 105. For example, the controller 102 may control the display unit 104 to display one or more images each representing media contents as a media wall of a user interface when the media wall setup unit 103 forms the media wall with images. The controller 102 may drive a player corresponding to an image selected by a user from the media wall. For example, a user may select an image representing an audio file, and the controller 102 may accordingly control an audio player installed in the user equipment 100 to play the audio file. Furthermore, the controller 102 may control the display unit 104 to display information associated with the audio file while playing back the audio file. For example, the information may include the artist, title, and album name associated with the played audio file.

The media wall setup unit 103 may set up a media wall based on the media contents stored in the memory 105. For example, the media wall setup unit 103 may divide a background screen of the media wall into a plurality of sub-screens based on the number of the stored media contents, extract at least one image included in the media contents, and arrange the extracted at least one image into the sub-screen.

The media wall setup unit 103 may set up sizes of sub-screens differently according to the preference of a user. The size of each of the extracted images may be equal to or different from the size of each of the sub-screens to be disposed on. If the size of a sub-screen is equal to the size of an extracted image, the media wall setup unit 103 under the control of the controller 102 may arrange the extracted image on the sub-screen without changing its size. On the other hand, if the size of a sub-screen is different from the size of an extracted image, the media wall setup 103 under the control of the controller 102 may dispose the extracted image on the sub-screen at an adjusted size to correspond to the size of the sub-screen.

The media wall setup unit 103 may retrieve a play type of a media content associated with the extracted image. The media wall setup unit 103 may form a media wall by mapping play type information to at least one image and arranging the at least one image in the media wall.

The display unit 104 may display information generated during operations of the user equipment 100 and/or display results of the operations. For example, the display unit 104 may display a result of performing operations in each constituent element of the user equipment 100. The display unit 104 may display a list of play types of media contents stored in the memory 105. The display unit 104 may display a media wall formed or set up by the media wall setup unit 103. The display unit 104 may display information associated with media contents. The display unit 104 may display an operation status of the user equipment 100, such as a battery status, a signal intensity, a date, and/or a current time.

The display unit 104 may include a liquid crystal display (LCD), an organic light emitting display (OLED), or an electrophoretic display (EPD).

The memory 105 may store applications, programs, data, and/or information used by constituent elements of the user equipment 100. The memory 105 may also store media contents. Furthermore, the memory 105 may store images, play types related to the images, and/or information on mapping between the images and the play types thereof. The memory 105 may store a media wall formed or set up by the media wall setup unit 103.

The memory 105 may provide stored information and data to the controller 102, the display unit 104, and/or the media wall setup unit 103, in response to requests therefrom. The memory 105 may include a plurality of sub-memories or be divided into a plurality of memories. For example, the memory 105 may be formed of a read only memory (ROM), a random access memory (RAM), and/or a flash memory.

In accordance with an embodiment of the present invention, a media wall may be configured of a plurality of images each representing a respective one of media contents stored in a memory. When a user selects an image displayed on the media wall, a user equipment may play back a desired media content corresponding to the selected image and/or display information related to the played media content.

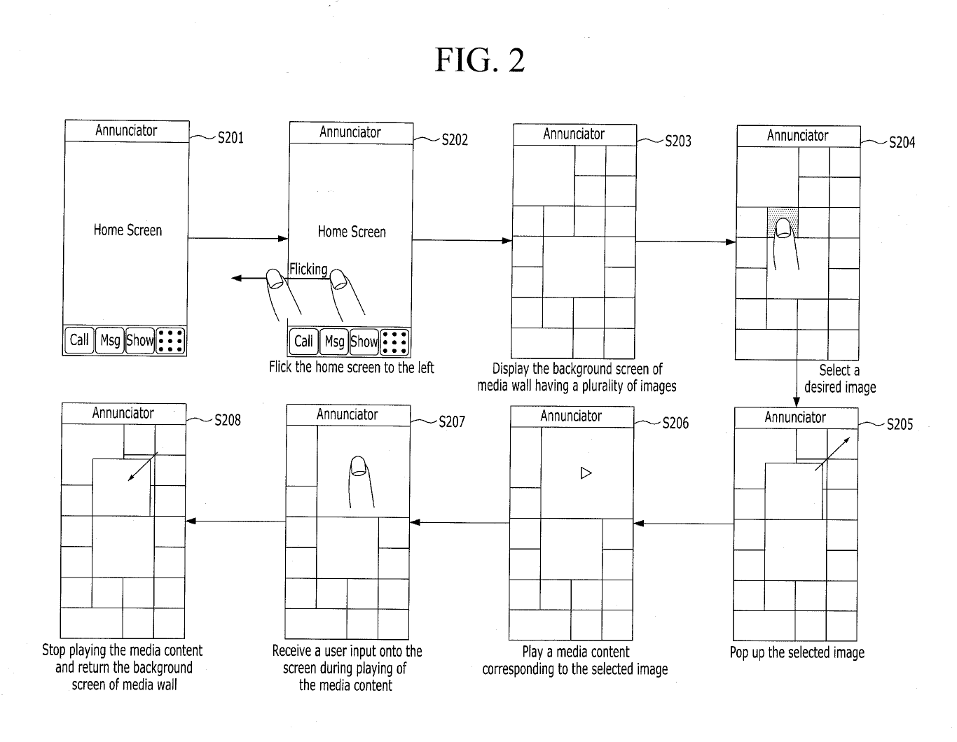

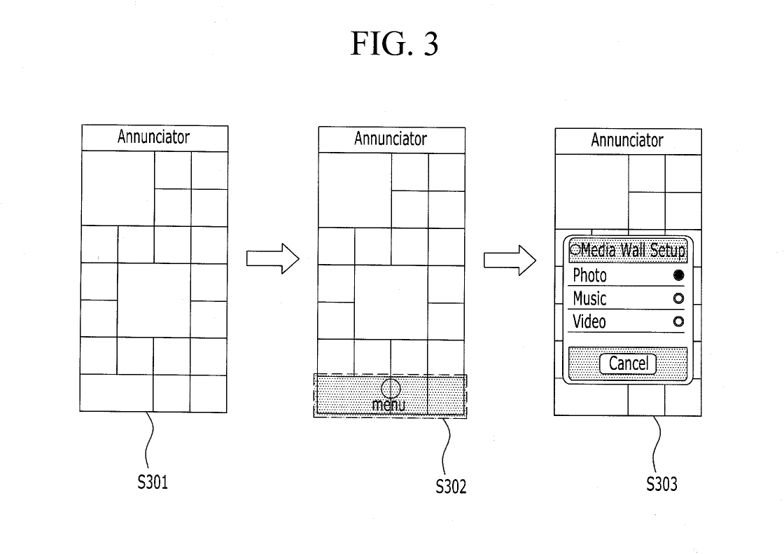

As described above, the media wall may be set up with images related to media contents stored in a memory. Hereinafter, examples of using the media wall formed with one or more images each representing a respective one of media contents, in accordance with an embodiment of the present invention will be described with reference to FIGS. 2 and 3.

FIG. 2 illustrates an example of playing a media content through a media wall formed with one or more images, in accordance with an embodiment of the present invention.

Referring to FIG. 2, the user equipment 100 may display a home screen having a plurality of icons and menu keys on the display unit 104 and wait for a user input to be entered S201. The user equipment 100 may receive a user input for starting a media wall S202. The user input may be any action that generates a signal to invoke at least one function of the user equipment. For example, a user may flick a home screen toward the left, right, up or down by a finger or by various types of pointing devices.

Then, the user equipment 100 may display a background screen of the media wall having a plurality of images each representing a respective one of media contents S203. The background screen of the media wall may include at least one image representing each of the media contents stored in the memory 105. For example, the media contents may include photos, audio tracks, video clips, and movies. The background screen of the media wall may be divided into sub-screens. For example, the media wall setup unit 103 may divide the background screen of the media wall into a plurality of sub-screens based on the number of the media contents stored in the memory 105. The sub-screens may be the same or different from each other in terms of size and/or arrangement. For example, the sizes and/or arrangements of the sub-screens may vary according to the preference of a user.

The user equipment 100 may receive a selection of a desired one of the displayed images S204. For example, a user may select an image of the displayed images by using a finger or any pointing device.

The user equipment 100 may enlarge the selected image to a certain size and the enlarged image may be popped up for a certain time period S205. Then, a desired media content corresponding to the selected image may be played S206. For example, the controller 102 may retrieve a play type information of the desired media content from the memory 105 and execute a corresponding application to play the desired media content corresponding to the selected image. For example, during the playing of the media content, the display unit 104 may display information related to the played media content, such as the title, the artist, and the album name.

When a user input is received on a screen displaying the media content while the media content is playing S207, the user equipment 100 may stop playing the media content and the media wall may return to the initial condition S208.

In accordance with an embodiment of the present invention, a background screen of a media wall may be displayed by sorting media contents according to play types such as photos, music, and video.

FIG. 3 illustrates an example of displaying a media wall by sorting media contents according to play types, in accordance with an embodiment of the present invention.

Referring to FIG. 3, a user equipment 100 may display a background screen of a media wall that is formed with a plurality of images representing various types of media contents such as photos, audio tracks, video files, etc. S301.

When a user wants to see only a certain type of media content, the user may input an instruction while the media wall is displayed S302. For example, a user may push a menu key displayed on the display unit 104.

Then, a list of types of media contents may be displayed for a user to select one of the types S303. For example, a window showing a list of media content types such as photos, music, and video may be popped up on the background screen of the media wall. When a user selects one of the types of media contents, the user equipment 100 may sort the media contents and display only the images corresponding to the selected type of media content. Accordingly, a user can easily and conveniently pick a desired media content to be played.

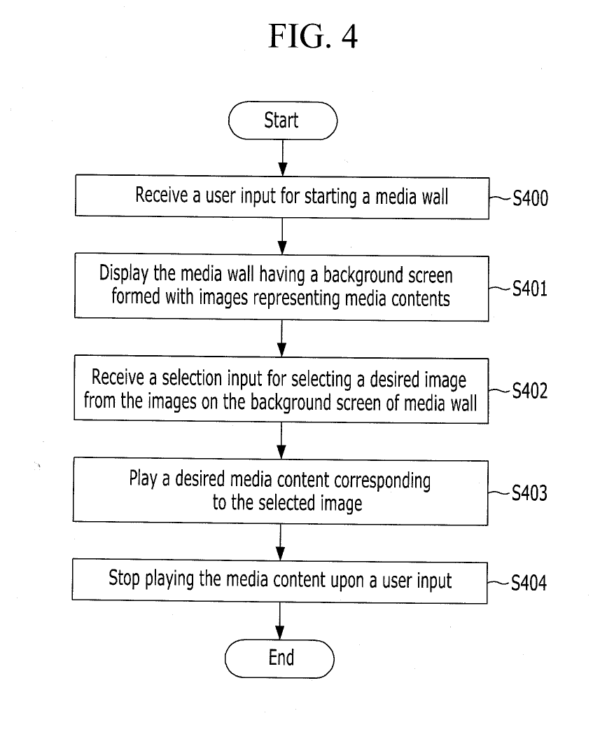

FIG. 4 illustrates a method for providing a media wall as a user interface for playing media contents in a user equipment, in accordance with an embodiment of the present invention.

Referring to FIG. 4, a user input for starting a media wall may be received S400. For example, the user may flick a home screen toward the left, right, up or down to start the media wall as a user interface for playing media contents.

When the user input for starting the media wall is received, a background screen of the media wall may be displayed, which is formed with one or more images each representing a respective one of the media contents S401. For example, the images may include an image that is included in a media content, such as a picture, an album jacket, a movie poster, etc.

Then, the user may select a desired image of the displayed images on the background screen of the media wall S402. For example, the user may input a selection of an image representing a media content, which he/she wants to see, watch or listen to, through the input unit 101 by using a finger or various types of pointing devices. For example, the user equipment 100 may enlarge the selected image to a certain size and the enlarged image may be popped up for a certain time period.

When the user selects the desired image, a media content corresponding to the selected image may be played S403. For example, the controller 102 may retrieve a play type information of the desired media content from a memory 105 and execute a corresponding application to play the desired media content corresponding to the selected image. For example, during playing of the media content, the display unit 104 may display information related to the played media content, such as the title, the artist, and the album name.

Then, upon a user input being received on a screen of displaying the media content while the media content is playing, the user equipment 100 may stop playing the media content and the media wall may return to the initial condition S404.

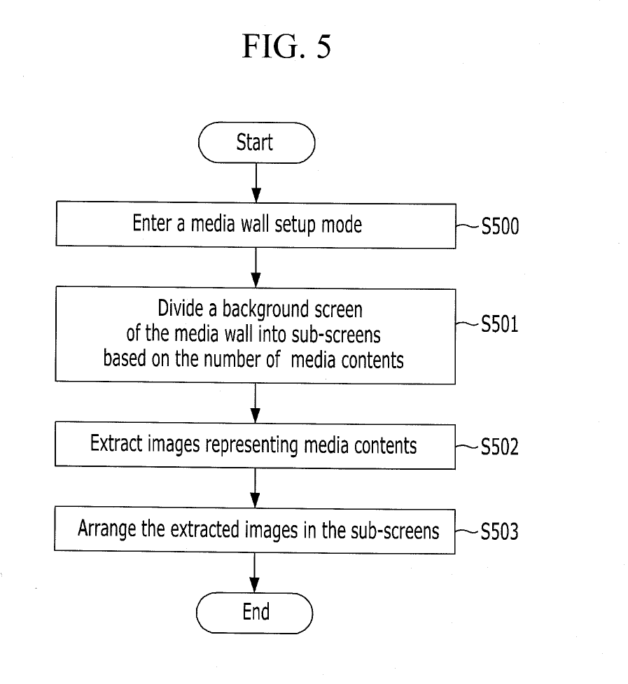

As described above, a background screen of a media wall may be set up with one or more images related to media contents stored in a memory of a user equipment. Hereinafter, an example of setting up a background screen of a media wall as a user interface for media contents, in accordance with an embodiment of the present invention, will be described with reference to FIG. 5.

FIG. 5 illustrates a method for setting up a media wall in a user equipment, in accordance with an embodiment of the present invention.

Referring to FIG. 5, a media wall setup mode may be entered upon a user input S500. For example, in accordance with an embodiment of the present invention, the input unit 101 of the user equipment 100 may display a home screen before setting up a background screen of a media wall. The home screen may be a default graphical user interface (GUI) that a user may interact with in order to enter inputs and/or requests. The GUI may output information in response to various user requests.

For example, before setting up the media wall as a user interface for media contents, the home screen may include a wallpaper such as a background image and a plurality of icons and menu keys displayed on the wallpaper. The plurality of icons may include a home screen setting icon for invoking a home screen setting function.

When the user selects the home screen setting icon, the user equipment 100 may carry out a home screen setting function. In accordance with an embodiment of the present invention, by using the home screen setting function, the user may set up the home screen including setting up a media wall as a user interface for media contents.

When the media wall setup mode starts, a background screen of the media wall may be divided into a plurality of sub-screens according to the number of the media contents S501. For example, upon receiving a user input for starting the media wall setup mode, the media wall setup unit 103 under the control of the controller 102 may divide the background screen of the media wall into one or more sub-screens based on the number of the media contents stored in the memory 105. For example, the sizes of the sub-screens may be equal to or different from each other. For example, the number of sub-screens may be equal to the number of the media contents stored in the memory 105.

Then, each image representing a respective one of the media contents may be extracted S502. For example, the images may include an image that is included in a media content, such as a picture, an album jacket, a movie poster, etc.

Then, the extracted images may be arranged in the sub-screens S503. For example, the media wall setup unit 103 under the control of the controller 102 may arrange the extracted images representing the media contents in the sub-screens of the media wall. If the size of a sub-screen is equal to the size of an image, the media wall setup unit 103 under the control of the controller 102 may dispose the image on the sub-screen without changing the size of the image. On the other hand, if the size of a sub-screen is different from the size of an image, the media wall setup unit 103 under the control of the controller 102 may dispose the image on the sub-screen while adjusting the size of the image to correspond to the size of the sub-screen. After arranging the images on the sub-screens of the media wall, the positions and types of the arranged images with corresponding media contents may be mapped and the mapping results may be saved in the memory 105.

In accordance with embodiments of the present invention, when a user selects a desired image displayed on a media wall, a user equipment may play back a desired media content corresponding to the selected image by executing a corresponding application to play the desired media content. Accordingly, the user can conveniently and quickly enjoy his/her favorite media contents.

In accordance with embodiments of the present invention, the methods for setting up and providing a media wall as a user interface for media contents may be realized as a program and stored in a computer-readable recording medium such as a CD-ROM, a RAM, a ROM, floppy disks, hard disks, magneto-optical disks, and the like. Such can be easily implemented by those skilled in the art to which the present invention pertains, and thus further description will not be provided herein.

The terms used in the present application are merely used to describe particular embodiments, and are not intended to limit the present invention. An expression used in the singular encompasses the expression of the plural, unless it has a clearly different meaning in the context. In the present application, it is to be understood that the terms such as “including” or “having,” etc., are intended to indicate the existence of the features, numbers, operations, actions, components, parts, or combinations thereof disclosed in the specification, and are not intended to preclude the possibility that one or more other features, numbers, operations, actions, components, parts, or combinations thereof may exist or may be added.

Unless otherwise defined, all terms used herein, including technical or scientific terms, have the same meanings as those generally understood by those with ordinary knowledge in the field of art to which the present invention belongs. Such terms as those defined in a generally used dictionary are to be interpreted as having meanings equal to the contextual meanings in the relevant field of art, and are not to be interpreted as having ideal or excessively formal meanings unless clearly defined as having such in the present application.

Although embodiments of the present invention have been described herein, it should be understood that the foregoing embodiments and advantages are merely examples and are not to be construed as limiting the present invention or the scope of the claims. Numerous other modifications and embodiments can be devised by those skilled in the art that will fall within the spirit and scope of the principles of this disclosure, and the present teaching can also be readily applied to other types of apparatuses. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A method for providing a user interface for media contents in a user equipment, the method comprising;
retrieving media contents from a memory of the user equipment;
forming a background screen of the user interface from at least one image, wherein each image of the at least one image represents a respective one of the retrieved media contents;
displaying the user interface having the background screen formed from the at least one image representing the media contents;
selecting a desired image from the at least one image of the displayed user interface; and
playing a desired media content corresponding to the selected desired image.

2. The method of claim 1, wherein the forming the background screen of the user interface comprises:
dividing the background screen of the user interface into at least one sub-screen based on a number of the media contents;
extracting the at least one image;
arranging the extracted at least one image in the at least one sub-screen to form the background screen;
mapping the arranged at least one image with corresponding media contents; and
storing a result of the mapping.

3. The method of claim 2, wherein the dividing the background screen into the at least one sub-screen comprises:
dividing the background screen into the at least one sub-screen such that each one of the at least one sub-screen has a same size.

4. The method of claim 2, wherein the dividing the background screen into the at least one sub-screen comprises:
dividing the background screen into the at least one sub-screen such that ones of the at least one sub-screen have varying sizes.

5. The method of claim 2, wherein the dividing the background screen into the at least one sub-screen comprises:
dividing the background screen into a number of sub-screens corresponding to the number of the media contents stored in the memory.

6. The method of claim 2, wherein the arranging the extracted at least one image in the at least one sub-screen comprises:
controlling at least one of a size and a position of each image of the extracted at least one image according to a user preference associated with each of the media contents.

7. The method of claim 1, wherein the displaying the user interface having the background screen formed from the at least one image comprises:
receiving a selection input for selecting a desired type of media content to be displayed;
sorting the media contents according to type; and
displaying ones of the at least one image that correspond to the desired type of media content.

8. The method of claim 7, wherein the desired type of media content comprises a photograph, music, or video.

9. The method of claim 2, wherein the playing the desired media content corresponding to the selected image comprises:
receiving a selection input for selecting the desired image from the background screen;
extracting, based on the stored result of the mapping, media content information corresponding to the selected desired image;
executing an application corresponding to a type of the desired media content; and
playing the desired media content using the corresponding application.

10. The method of claim 9, wherein information corresponding to the desired media is displayed while the desired media content is played.

11. An apparatus for providing a user interface for media contents in a user equipment, the apparatus comprising;
an input unit configured to receive an input from a user;
a memory configured to store the media contents;
a formation unit configured to retrieve the media contents from the memory, and configured to form a background screen of the user interface from at least one image, wherein each image of the at least one image represents a respective one of the retrieved media contents; and
a display unit configured to display the user interface having the background screen formed from the at least one image representing the media contents, and configured to display information corresponding to an image selected from the displayed background screen formed from the at least one image.

12. The apparatus of claim 11, wherein the formation unit is configured to:
divide the background screen of the user interface into at least one sub-screen based on a number of the media contents stored in the memory;
extract the at least one image;
arrange the extracted at least one image in the at least one sub-screen to form the background screen;
map the arranged at least one image with corresponding media contents; and
store a result of the mapping in the memory.

13. The apparatus of claim 12, wherein the formation unit is configured to divide the background screen into the at least one sub-screen such that each one of the at least one sub-screen has a same size.

14. The apparatus of claim 12, wherein the formation unit is configured to divide the background screen into the at least one sub-screen such that ones of the at least one sub-screen have varying sizes.

15. The apparatus of claim 12, wherein the formation unit is configured to divide the background screen into a number of sub-screens corresponding to the number of the media contents stored in the memory.

16. The apparatus of claim 12, wherein at least one of a size and a position of each image of the extracted at least one image is controlled according to a user preference associated with each of the media contents.

17. The apparatus of claim 11, wherein the formation unit is further configured to:
receive a selection input for selecting a desired type of media content to be displayed while the user interface having the background screen formed from the at least one image is displayed;
sort the media contents according to type; and
display, on the display unit, ones of the at least one image that correspond to the desired type of media content.

18. The apparatus of claim 17, wherein the desired type of media content comprises a photograph, music, or video.

19. The apparatus of claim 11, wherein the at least one image representing the media contents comprises an image that is included in the media contents.

20. A computer program product embodied on a computer-readable storage medium, which when executed by a computer of a user equipment, the computer program product causes the computer to perform a method, the method comprising:
retrieving media contents from a memory of the user equipment;
forming a background screen of the user interface from at least one image, wherein each image of the at least one image represents a respective one of the retrieved media contents;
displaying the user interface having the background screen formed from the at least one image representing the media contents;
selecting a desired image from the at least one image of the displayed user interface; and
playing a desired media content corresponding to the selected desired image.
